(19) United States
(12) Patent Application Publication
(10) Pub. No.: US 2011/0290721 A1
(43) Pub. Date: Dec. 1, 2011

(54) Biological Processing for Beneficial Use

(75) Inventor: Richard Lee Aho, Marquette, MI (US)

(73) Assignee: Richard Lee Aho, Marquette, MI (US)

(21) Appl. No.: 12/500,597

(22) Filed: Jul. 10, 2009

Related U.S. Application Data
(60) Provisional application No. 61/134,647, filed on Jul. 11, 2008.

(51) Int. Cl. C02F 3/30; B09C 1/00; C02F 3/00

(52) U.S. Cl. 210/605; 210/610; 210/137; 405/128.1

(57) ABSTRACT

This method improves and controls ex-situ or in-situ, aerobic or anaerobic digestion of organic materials and toxic or damaging compounds through increased control of multiple chemical and biological settings and conditions. The ability to control flow, natural processes, and biological activity while adjusting to individual site conditions modify results. Large quantities of modified or adjusted organisms are developed and utilized. Identification and strategic manipulation of the multiple elements of the system result in performance modifications. Energy is utilized to manipulate characteristics of a natural degradation system.

### CROSS-REFERENCE TO RELATED APPLICATIONS N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISK APPENDIX

N/A

### BACKGROUND OF THE INVENTION

This application references provisional application No. 61/134,647. Biological Processing for Beneficial Use (BPBU) is the preparation, mixing, cultivating, sheltering, harvesting, and manipulation of organisms and additives to process organic materials, waste, and contaminated materials into beneficial products or at least benign filler. This invention will process organic material, waste, contaminated materials, reactive materials, toxins, and greenhouse gas at efficiencies that have not been achieve before.

### BRIEF SUMMARY OF THE INVENTION

This invention is an improved waste processing and remediation device. With the exception of the Transformer system current processes are carried out in small containers or are crude systems with little control or intention of optimizing the degrading organisms. The addition of non-waste materials to what is normally considered waste to increase the value and effectiveness of the end product will be utilized. BPBU is the biological processing of organic materials such that large portions of the liquid and solid materials are converted to commodities of some value. In addition to being harmless, the intent is to modify large quantities of liquids and solids such that they are highly beneficial and useful materials after processing. The flow of organisms and materials enhances exposure and treatment.

The innovative manipulation of organisms in countless numbers and the optimized or improved processing of organic materials make this invention unique. The extraction, injection, and manipulation of multiple generations of live bacteria has never been accomplished before. The scale of the invention facilitates processing at an effectiveness and speed that is not found in nature. Transfer of organism from multiple facilities and/or multiple locations within facilities produces optimized hybrid microorganisms. Unnaturally large numbers of optimized organisms, in quantities measured in millions of gallons and thousand of cubic yards offer new levels of environmental benefits and protection. Combined and sequential anaerobic and aerobic treatment, the improved energy potential of the modified anaerobic organic materials, and the ability to mix and degrade toxins makes the invention unique and patentable.

1. In addition to the features of the Transformer process, BPBU features extraction, nurturing, injection, and cultivation of living organisms from water and solids by means of pumping, vacuum, siphon, pressurization, or gravity. Materials with high solids content can be digested at high rates of degradation in both anaerobic and aerobic states.

2. The use of a temporary or/and flexible containment “cap” serves to isolate the materials, induce internal flows and create an optimized processing environment. The control of oxygen content and pressures (both positive and negative) of gases, liquids, and biological activity is utilized to induce flow and vitality.

3. The use of massive quantities of liquid, solids, and gas inside the large high capacity containments systems creates optimized or improved processing of organic materials. Beneficial organisms that are manipulated, destroyed, digested, injected, extracted, circulated, bred, trained, and or moved in both aerobic and anaerobic states that optimize both the operational capability and economics of degradation of the organic materials.

4. The in-situ use of massive quantities of liquid, solids, and gas inside the large high capacity containments systems. Beneficial organisms that are manipulated, destroyed, digested, injected, extracted, circulated, bred, trained, and or moved in both aerobic and anaerobic states that optimize both the operational capability and economics of degradation of the organic materials at contaminated sites.

5. Beneficial biological mixtures are developed and produced in quantities greater than the current miniscule 200 gallons practical limit of compost brewers. The issues of consistency and quality are dramatically improved with the ability to produce uniform multimillion-gallon batches of materials that increase vitality, disease/insect resistance, and/or growth in plants.

6. With the process composting operations are retrofitted or created to minimize cost, increase efficiency, and/or improve control and processing of contaminants.

7. Sequential treatment utilizing solids, liquids, and gas in variations of anaerobic and aerobic digestion and processing optimizes treatment flexibility.

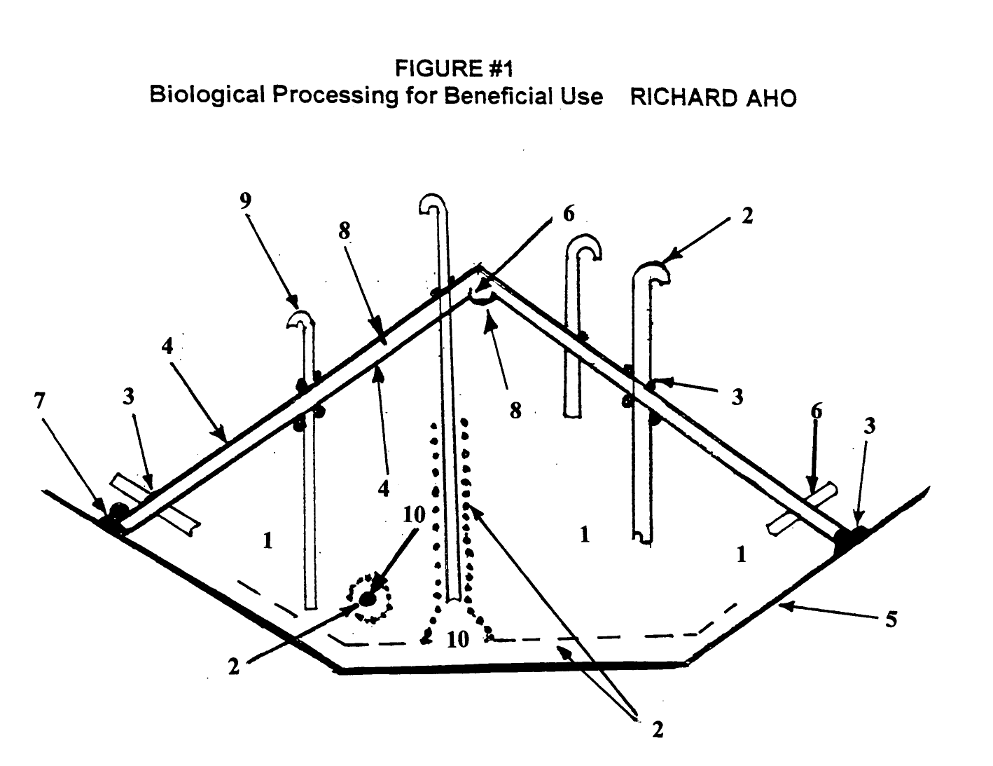

FIG. 1
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

A cross-section of an anaerobic solids portion of a BPBU facility is shown. External vacuum/pressurization equipment can extract gas or maintain pressure from a header and feeder grid (1, 2). One or more horizontal or vertical porous or hollow media will extract liquid, inject bacteria, liquids, or gas to enhance biological activity and create flow. This extraction equipment (10) is in addition to or without the use of a conventional leachate collection system that may be found on the bottom of the containment. The surface header and feeder can be utilized in both the anaerobic and aerobic scenarios. The outer membrane is flexible and expands as gas pressure increases. The travel of liquid through the organic material optimizes aerobic degradation or anaerobic degradation and gas production depending on the application. Pumps (10) can be located within the mass to extract liquids and organism. External pumps (10) can pressurize one point while vacuum (10) is applied at another to induce maximum flow. Saturated materials can be aerated and flow can be established by injecting on one side while extracting on the other. The entire saturated zone can be aerated in place without fear of fire.

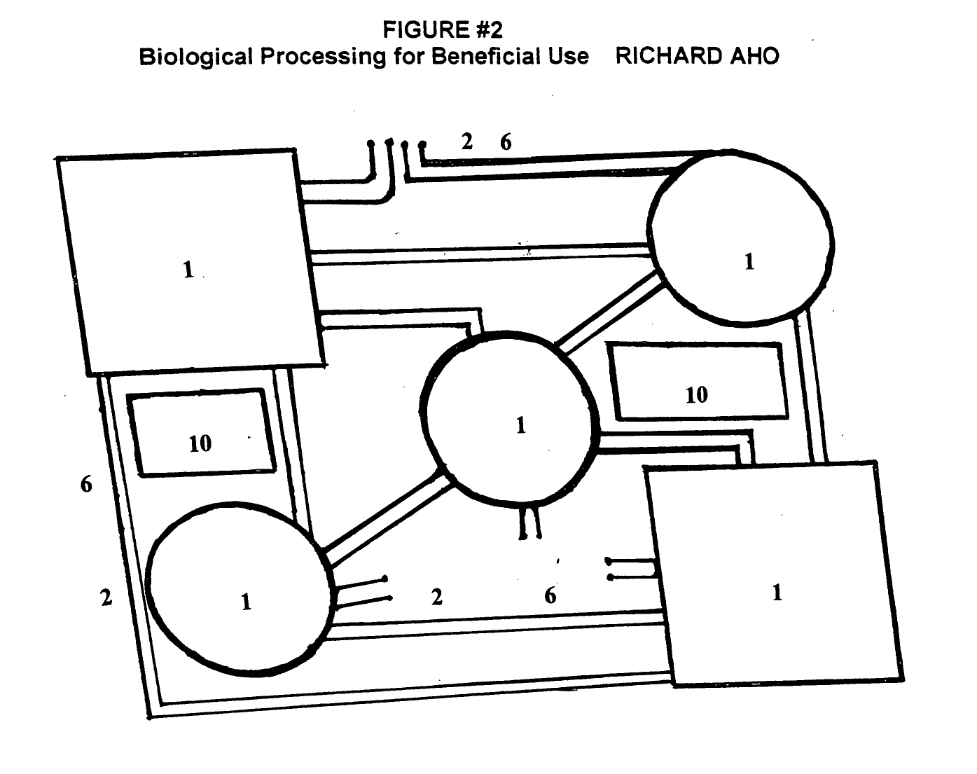

FIG. 2
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

The combination of aerobic organic material and other solids containments (1), aerobic liquid storage (1) with anaerobic organic material and other solids containments (1), with anaerobic gas containment (1) and anaerobic liquid reservoirs (1) greatly increases the digestive power of the treatment system. The sequential movement, injection, extraction, and monitoring (2, 6, 9, 10) exposure of contaminants to anaerobic and aerobic environments will degrade persistent contaminants such as chlorinated compounds, drugs, and toxins. The combination of treatments will degrade mixtures that would not be economically affected by a single treatment such as wastewater facilities. The combined system can be used to accelerate the “normal” aerobic and anaerobic degradation. The multi-vessel system can be extracted and injected through access points (2), with mechanical forces (10) to be used to brew large consistent batches of beneficial microbial mixtures. The organism in either a liquid or solid carrier, can be applied beneficially both on the current site as seed and treatment or to other sites as seed, treatment, fertilizer, and inoculants. Multigenerational adapted batches of organic material degrading organisms can be developed and shipped to other sites to carry out both in situ and ex situ treatment. The developing batches or continuous streams of organisms can be treated with organic material, contaminants, and/or substances similar to contaminants, to acclimate the treatment organisms and improve their ability to degrade.

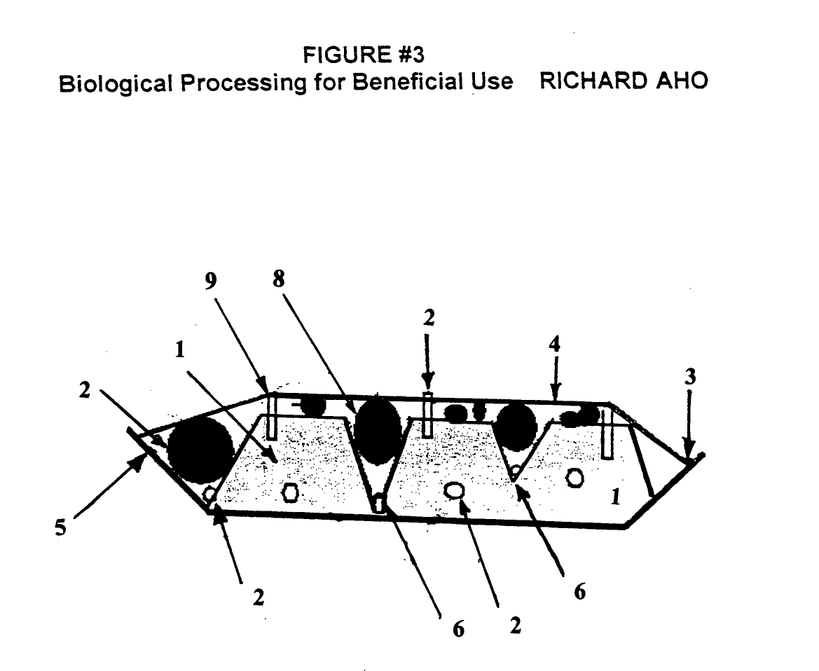

FIG. 3
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

A channel (3) in the solids is not required, but can be helpful as gas, liquids, organisms, (1) etc. can be more easily forced to flow in or out. Vacuum extraction (10) and surface pressurization (10) also are more effective with more surface area and less material thickness. Compost (8) can be utilized in place of a gas destruction system. The best mode aerobic operation of the invention calls for one or more channels (2) to be loosely filled with digested organic material that emission flow through from the organic materials. Perforated piping or rolled membranes, screens, or any porous material (2) can be inserted into the mounds or layers of compost (8) to facilitate gas migration and/or expose emissions to degrading organisms in the aerobic application.

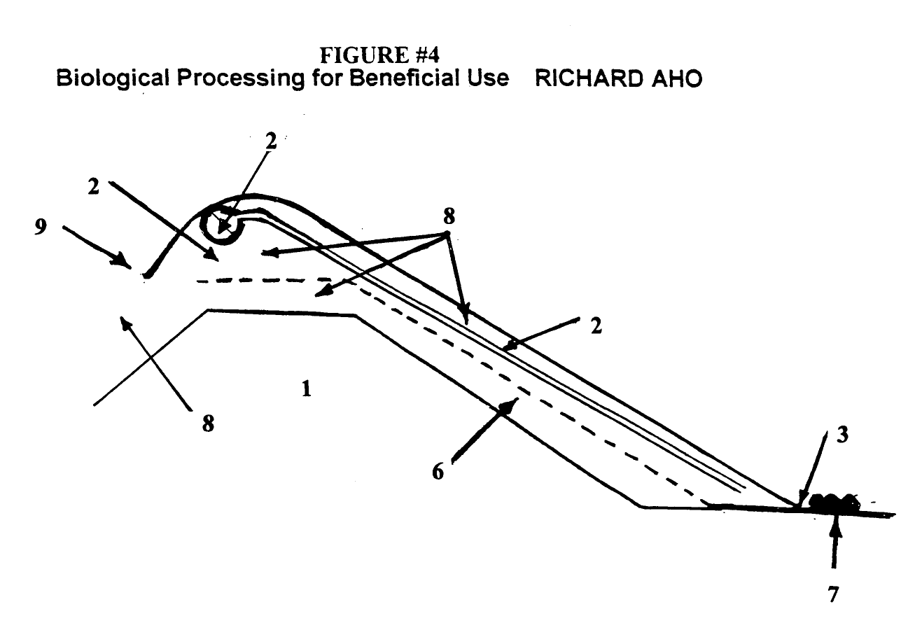

FIG. 4
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

A channel (6) in the solids (1) is not required, but can be helpful as gas, liquids, organisms, (1) etc. can be more easily forced to flow in or out under the membrane (4). Vacuum extraction (10) and surface pressurization (10) also are more effective with more surface area and less material thickness. Compost (8) can be utilized in place of a gas destruction system. Migration can be manipulated with an open depression (6) or other preferential channel. The best mode aerobic operation of the invention calls for one or more channels (2) to be loosely filled with digested organic material such that emission flow through from the organic materials. Perforated piping or rolled membranes, screens, or any porous material (2) can be inserted into the mounds or layers of compost (8) to facilitate gas migration and/or expose emissions to degrading organisms (8) in the aerobic application. Ballast (7) aids in the routing of the emissions and conditions can be monitored throughout the system (9).

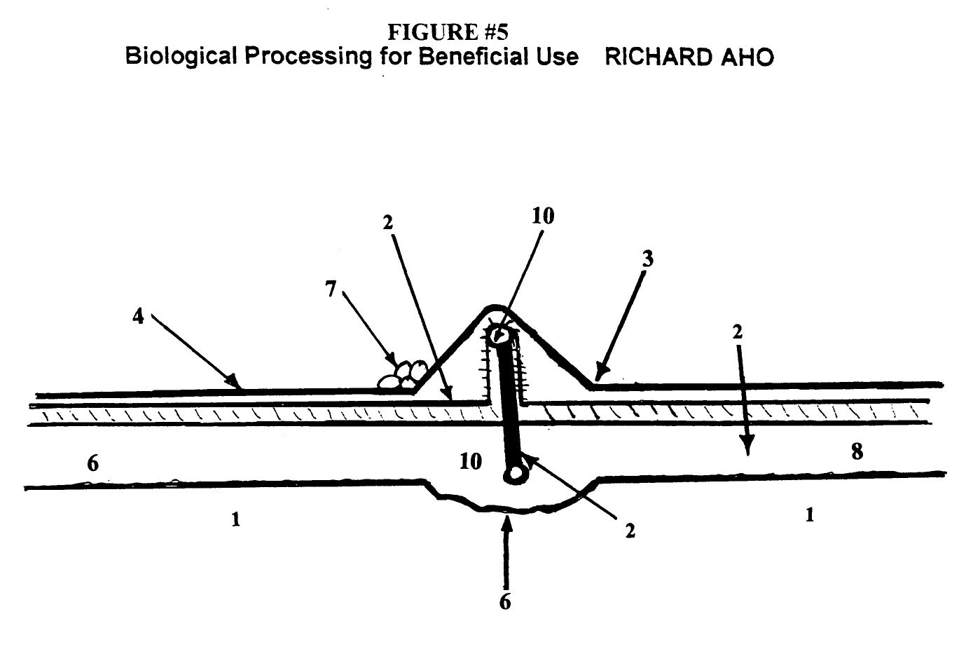

FIG. 5
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

A channel (6) in the solids (1) is not required, but can be helpful as gas, liquids, organisms, (1) etc. can be more easily forced to flow in or out under the membrane (4).

Vacuum extraction (10) and surface pressurization (10) also are more effective with more surface area and less material thickness. Compost (8) can be utilized in place of a gas destruction system. Migration can be manipulated with an open depression (6) or other preferential channel. The best mode aerobic operation of the invention calls for one or more channels (2) to be loosely filled with digested organic material such that emission flow through from the organic materials. Perforated piping or rolled membranes, screens, or any porous material (2) can be inserted into the mounds or layers of compost (8) to facilitate gas migration and/or expose emissions to degrading organisms (8) in the aerobic application. Ballast (7) aids in the routing of the emissions and conditions can be monitored throughout the system (9).

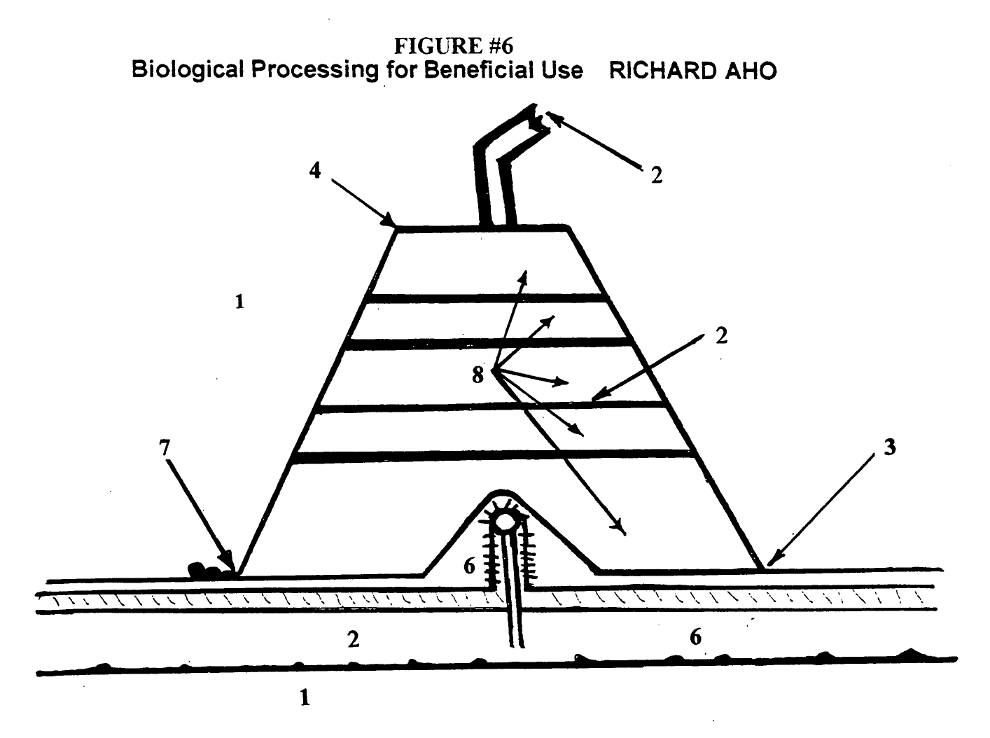

FIG. 6
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

The base of the slope is sealed (3) with soils or some other significant ballast (7) to prevent uncontrolled migration. A chimney containing emission-oxidizing material (8) influences gas flow with convection caused by the heating of the membrane (4) and materials (1). Vacuum extraction (10) and surface pressurization (10) also are more effective with more surface area and less material thickness. The cover will expand and contract with temperature. The slope base must be sufficiently secured to maintain control during the movements of the cap. Migration can be manipulated with an open depression (6) or other preferential channel. The best mode aerobic operation of the invention calls for one or more channels (2) to be loosely filled with digested organic material such that emission flow through from the organic materials. Perforated piping or rolled membranes, screens, or any porous material (2) can be inserted into the mounds or layers of compost (8) to facilitate gas migration and/or expose emissions to degrading organisms (8) in the aerobic application. Ballast (7) aids in the routing of the emissions and conditions can be monitored throughout the system (9).

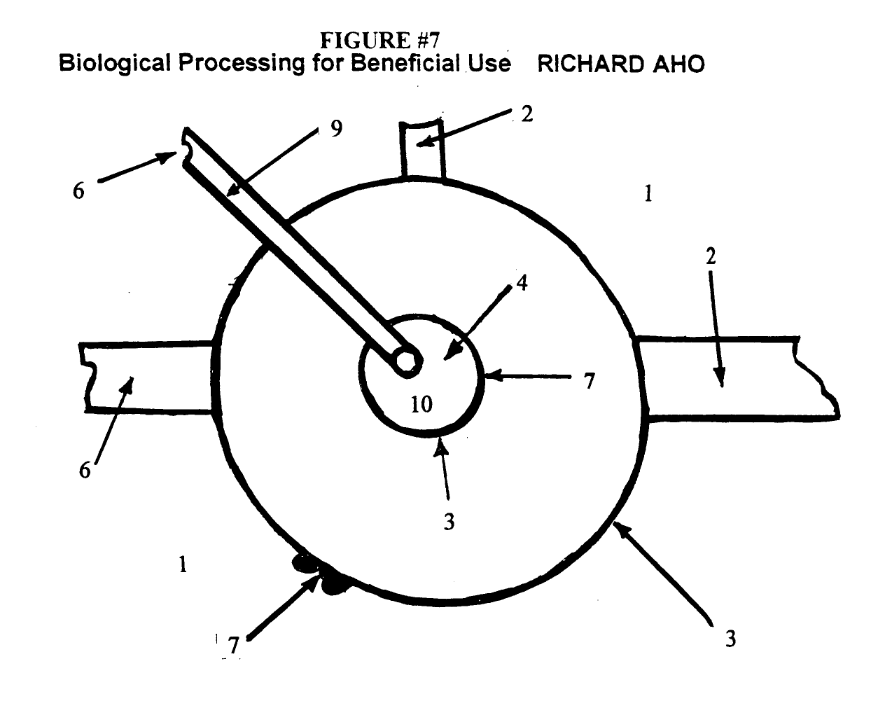

FIG. 7
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

A conventional biofilter can be substituted for the chimney and a vacuum system (10) can also be utilized to influence gas flow if greater control is desired. In the active anaerobic gas for energy, the extraction points are connected to a header. Migration can be manipulated with an open depression (6) or other preferential channel. The best mode aerobic operation of the invention calls for one or more channels (2) to be loosely filled with digested organic material such that emission flow through from the organic materials. Perforated piping or rolled membranes, screens, or any porous material (2) can be inserted into the mounds or layers of compost (8) to facilitate gas migration and/or expose emissions to degrading organisms (8) in the aerobic application.

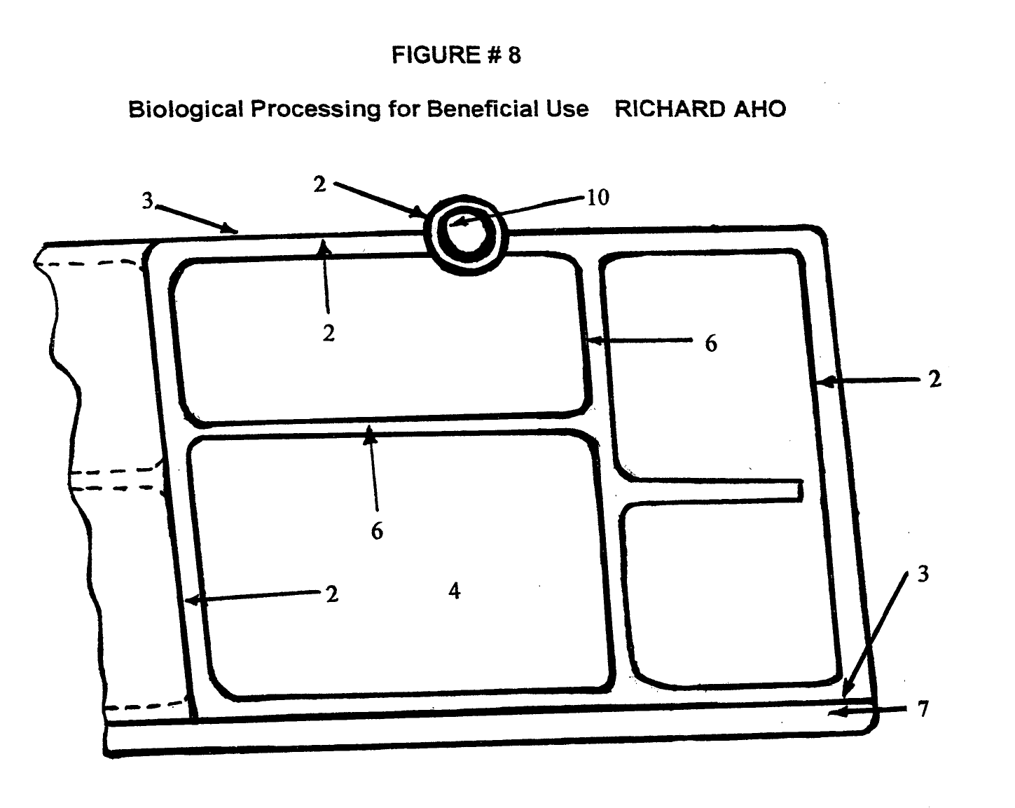

FIG. 8
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

This plan view of a slope illustrates the mounding of digested organic materials (8) and conveyance materials (such as piping) (2) (6) under an impermeable or partially permeable membrane (4). Slopes of the organic materials (8) are commonly between a one to three and a one to five ratio. The amount of gas being produced and the condition of the oxidizing material will dictate the arrangement. This cover is the best mode for the retrofit of existing landfills into a BPBU processing facility with passive gas treatment. Conveyance materials can be perforated pipe, rolled fencing, mesh, screens, or anything else that has high permeability (2).

The mounding, ballasting (7), sealed edges (3), and piping (2) facilitates preferential flow in and to the areas where the emission oxidizing organisms or extraction points are located. A layer of digested material (8) can cover the entire surface of the organic materials (or part of it). These oxidizing materials can be added after gas extraction is complete. When gas extraction is beneficial, the expansion of the flexible cap (4) under and around the ballast (7) on the surface serves as storage. Gas is extracted to maintain safe operating pressure. The trapped gas also assists the control of liquid in the organic materials. Gas between the organic material (8) and the cover can be heated to maintain optimum degradation conditions.

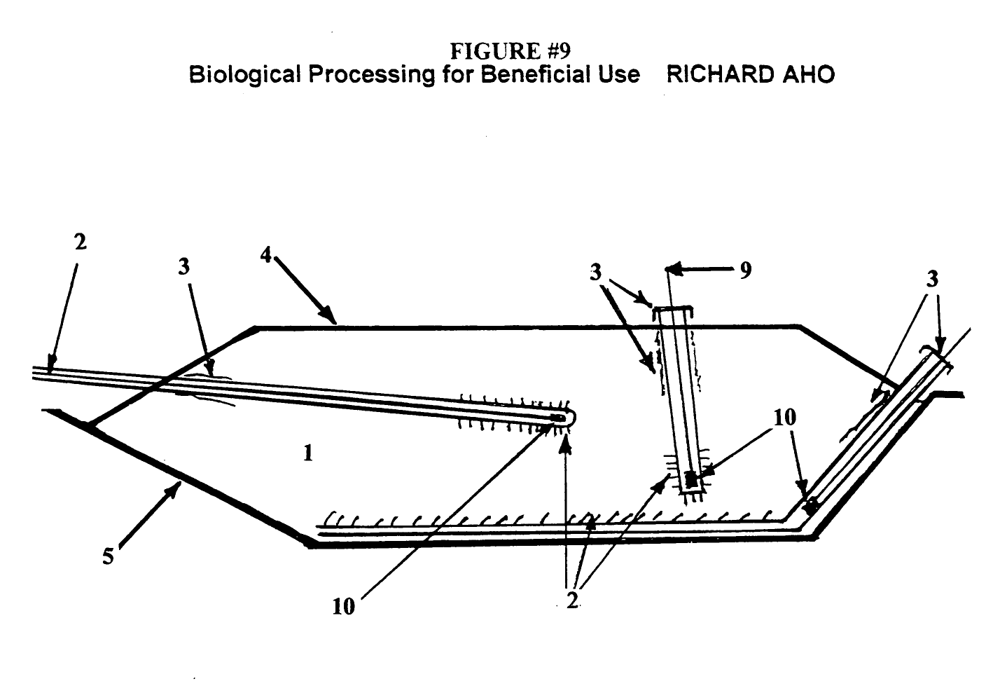

FIG. 9
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

A waste pile (1) that is being used to grow organism while digesting solids (1) and cleaning liquids can also be utilized to mix and dilute materials that would be too toxic to treat otherwise. The vacuum extraction (10) of liquid and organisms from the material mass (1) is an important feature of this invention. The conventional internal drainage (5) of the organic materials should be modified to minimize the filtering of the organisms. Extraction media can be any porous media within the pile (2) but will be referred to as piping (2) from this point on. The piping should be sealed from outside atmosphere such the internal flow of liquid and therefore the extraction of organism is maximized. Energy efficient siphon (10) arrangements can be achieved if sufficient elevation change is available. The use of Transformer technology in combination with anaerobic degradation is beneficial. The clogging associated with anaerobic digestion can be overcome in the input lines and media with forced (10) aerobic liquids. The use of aerobic liquid in the organic materials is a form of the Transformer process. Cleaning, flushing, and purging with aerobic liquid is an improvement of that invention and is a form of this invention. Wells and excavations (2) into areas of optimized biological activity facilitate the extraction and reintroduction of optimized organisms. Flow of liquids, gas, organisms, nutrients, and contaminants is utilized to create treatment opportunities that are not available in any other circumstance. Sealed vertical (3) sumps (2) can be produced by drilling, digging, or burying as waste is placed. The targeted removed solid is teeming with biological activity. Leaving sealed (3) sumps as the material is placed is a likely a best mode application. A perforated pipe (2) buried horizontally, is a good opportunity to extract bacteria that can be utilized to improve the breeding stock or the several other options this invention provides. Pumps or vacuum (10) connections in sumps can quickly remove bacteria and water and transport them to whatever area is most advantageous. The removal of the liquid accelerates the flow within the containment and improves treatment capabilities.

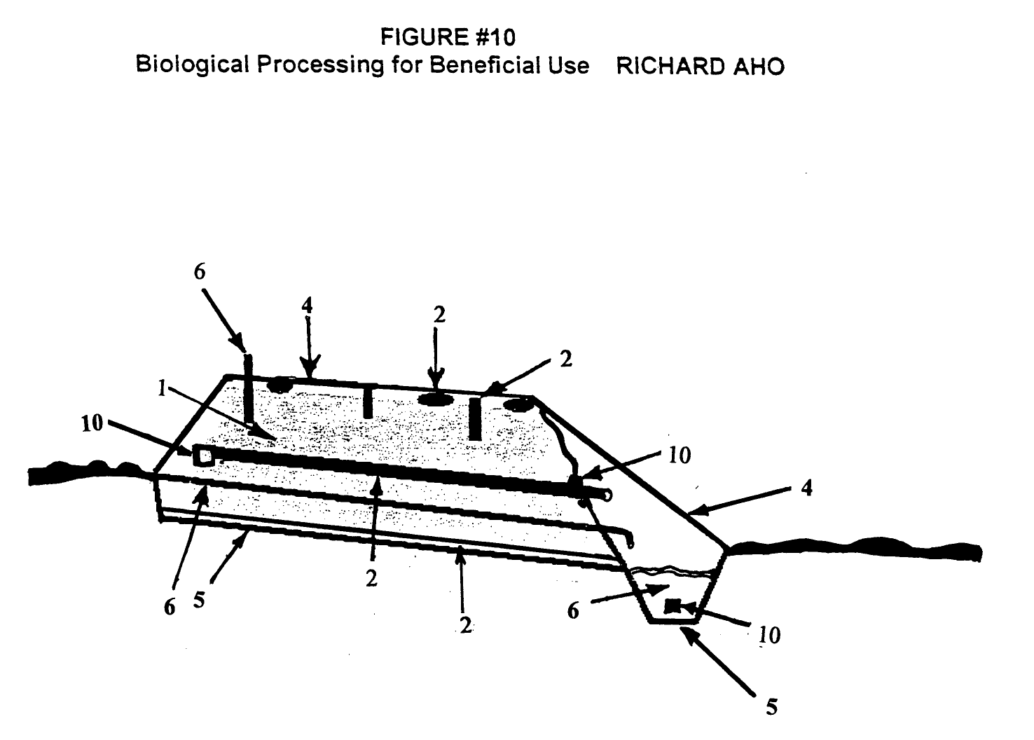

FIG. 10
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

Illustrated flow induction and the use of extraction to accelerate the migration of liquids, organisms, solids, and/or gas in the mass. In addition to the preferred use of gravity, the powered movements (10) of the elements of the mixture maximize exposure and treatment. The pump (10) in the reservoir moves liquids and organisms back to the materials through assorted conduits (2, 6). A waste pile (1) that is being used to grow organism while digesting solids (1) and cleaning liquids can also be utilized to mix and dilute materials (1) that would be too toxic to treat otherwise. The vacuum extraction (10) of liquid and organisms from the material mass (1) is an important feature of this invention. The conventional internal drainage of the organic materials should be modified to minimize the filtering of the organisms. Extraction media can be any porous media within the pile (2) but will be referred to as piping (2) from this point on. The piping should be sealed from outside atmosphere such the internal flow of liquid or gas (oxygen, methane, etc.) and the extraction of organism can be maximized. Energy efficient siphon (10) arrangements can be achieved if sufficient elevation change is available. The use of Transformer technology in combination with anaerobic degradation is beneficial. The clogging associated with anaerobic digestion can be overcome in the input lines and media with forced (10) aerobic liquids used for cleaning. The use of aerobic liquid in the organic materials is a form of the Transformer process. Cleaning, flushing, and purging with aerobic liquid is an improvement of that invention and is a form of this invention. Wells and excavations (2) into areas of optimized biological activity facilitate the extraction and reintroduction of optimized organisms. Flow of liquids, gas, organisms, nutrients, and contaminants is utilized to create treatment opportunities that are not available in any other circumstance. Sealed vertical (3) sumps (2) can be produced by drilling, digging, or burying as waste is placed. The targeted removed solid is teeming with biological activity. Leaving sealed (3) sumps (6) as the material (1) is placed is a likely a best mode application. A perforated pipe (2 or 6 or both) buried horizontally, is a good opportunity to extract bacteria that can be utilized to improve the breeding stock or the several other options this invention provides. Pumps or vacuum (10) connections in sumps can quickly remove bacteria and water and transport them to whatever area is most advantageous. The removal of the liquid (1) accelerates the flow within the containment (4, 5) and improves treatment capabilities.

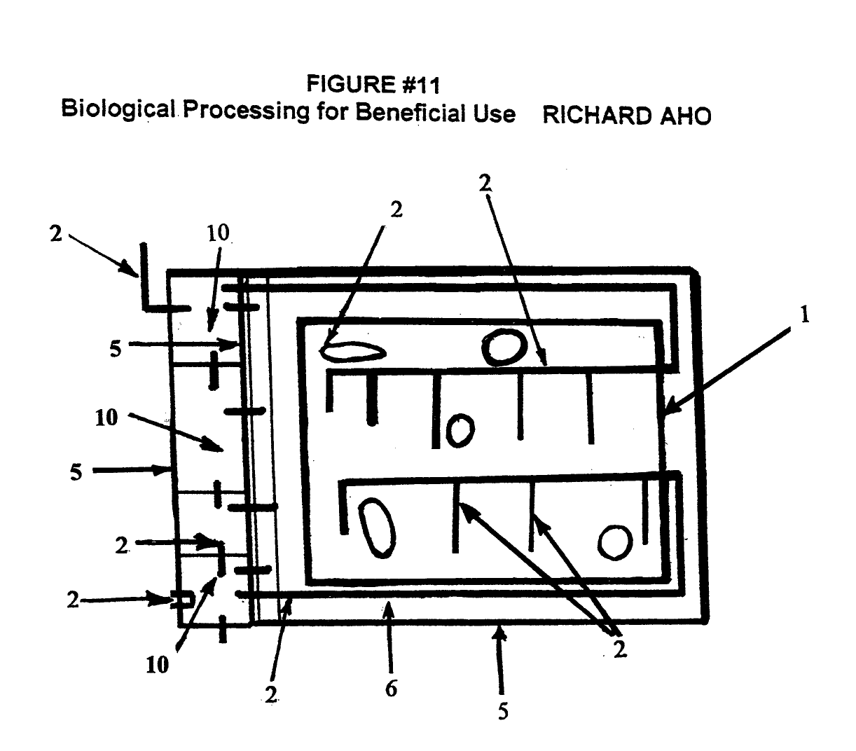

FIG. 11
1 anaerobic or aerobic material: solids, gasses and liquids,
2 Injection, transmission, and/or extraction points, consisting of drainage media, channels, or piping, vertical, horizontal, or angled
   for liquids, gasses, slurries, solids (injection, pressurization, siphoning)
   for vacuum extraction, gravity extraction, or pressure relief of liquids, gasses, slurries, within the mass or liquids or both
3 seals (multiple) liquids or gas or both—optional with aerobic or when redundant
4 covers—impermeable or not, optional with aerobic treatment
5 liners—impermeable as required—plastic, metal, masonry, composites, etc, or any other materials or mixture of materials
6 open channels that facilitate flow—optional or in lieu of drainage media, channels, or piping
7 ballast for seal or barrier
8 Compost and other biologically active filter media—optional for processing emissions
9 monitoring pts, multiple locations
10 pumps, suction lines, vacuum ports, blowers, siphons, and/or the end of a positive or negatively pressurized line—optional with performance requirements

Forced flow (10) and the use of open channels and piping (2, 6) is utilized to accelerate the migration of liquids, organisms, solids, and/or gas (1) in the mass. Isolation of anaerobic and aerobic liquid, solids or combinations facilitate treatment of difficult materials in both the liquids and the solids. Both gravity and powered materials movement can be utilized for biological, solid, gas, and liquid materials movement.

### DETAILED DESCRIPTION OF THE INVENTION

A typical application is one or more landfills (or any other organic materials) being treated with aerated liquid as described by the Transformer process. Powered extraction and forced flow are innovations of this invention that produces an array of opportunities. One or more liquid containment vessels are utilized to enhance biological activity and facilitate the reintroduction of the enhanced liquid and bacteria.

Organisms are extracted, manipulated, and utilized in one of more locations, characterizing a major improvement of existing technology. Movement of the organism is critical to effectiveness; dead organisms are of little value. The anaerobic portion of the invention provides a synergistic improvement in overall treatment capability, producing more degradation in toxic material, in less time. Treatment capabilities are expanded exponentially; environmental protection and remediation capabilities of our civilization are significantly expanded.

1. An emission capture and treatment system that contains any combination of headers, laterals, chimneys, vaults, blowers, vacuum pumps, and plenums. Combining some or all the components with impermeable and permeable masses of composted material and impermeable membranes makes an effective greenhouse gas collection and consumption system. These features facilitate the collection and treatment of emissions from partially treated and untreated materials. The invention feature greatly reduce emissions from both anaerobic and aerobic (conventional composting or Transformer) facilities. These control features facilitate the accurate measurement and verification of destruction of emissions. Final release of treated gas is controlled, isolated, and easy to test. Accurate measurement of emissions destruction provides the opportunity for emission credits.

The construction of piles of organic materials that are designed for open channel flow, superior drainage, and optimized internal flow facilitates cost effective and efficient processing. Aerated or anaerobic liquid are injected into the targeted material and flow distributes the organisms. Anaerobic treatment in best mode requires a cover to isolate the system from the atmosphere and facilitate the harvesting of the methane. Pressurizing the containment also increases flow and therefore biological activity.

A partially or completely covered mass of organic materials that has minimized emissions, controlled inputs, and maximized operational flexibility will be produced. BPBU features containment and control of emissions with minimized use of compost and easy emission treatment. The invention can also be utilized to increase treatment efficiency at bioreactor facilities, standard landfills, or an unlined wastemass. The BPBU containment can be substituted for a conventional cap on the old city dump. The invention can be utilized in any application that requires control of gas emissions and liquid flows. Emission treatment, biological digestion, and synergistic decomposition of persistent contaminants are some of the resultant benefits.

The movement of gasses can be facilitated by pumping, gas density, or thermal convection. The simplicity of the system means low costs and applications in remote settings.

Facilities utilizing this technology have the following characteristics:
improved containment and treatment of liquids and gasses
very low costs, minimal energy use, and excellent application to remote sites
actual site remediation for the same cost as capping
high efficiency treatment media—digested organics

2. The capability to produce beneficial mixture of water, bacteria, and nutrients through the manipulation and modification of aerobic and anaerobic environments is an important attribute of BPBU. The volume of solids and liquids that can be used for the various treatments is not limited. The larger the facility, the greater the biological diversity and opportunity for optimized treatment results. A BPBU facility can be set up on a contaminated site for the purpose of processing waste and remediating the site. Treatment can be ex situ, in situ, or both. The combination of solid and liquid containment makes it possible to control the process and therefore the results of the process. Addition of non-waste materials such as lime or other modifiers is available to mimic or change the characteristics of the treatment material or the site that will be treated. The use of the organic materials and the liquid containment to adjust pH, stabilize metals, and other treatments of undesirable and toxic characteristics can be accomplished by the invention. Processing large quantities of acid mine drainage liquid or in-situ treatment of a mine site is a practical application of the invention. The injection of anaerobic or aerated liquid into the organic materials and the processing of liquids in the containment facilitate the formation of beneficial microbial mixtures that can be utilized as nutrients and fertilizers. Growth of beneficial organisms is accomplished in both the liquid and solid material.

Transformer facilities clean liquids and aerobically digest solids. This invention takes the process further and furnishes larger quantities of beneficial bacteria, in addition to nutrients, for transfer to other facilities in both the liquid and solid form. In order to function with maximum benefits the aerobic and anaerobic bacteria must be maintained until they are applied to the recipient site. Dead bacteria are of minimal value. Addition of oxygen, food, and/or refrigeration may be required to maintain the organisms. The stabilized nutrients of the BPBU system are available for utilization by the recipient site. Liquid circulation of the Transformer process is enhanced through the organics to produce beneficial mixtures.

Addition of large organic contributors such as manure, greenwaste, sewage, sludge, and foodwaste can be utilized to optimize the soil enhancement value of the resultant solids and liquids. The solid and liquid treatment furnished by the invention offer many advantages over the existing systems. Nutrients are stabilized or preserved in forms that are available to recipient plants. High strength wastes, such as manure or sludge are buffered, but much of the nutrients the materials originally contain are preserved. Odors, undesirable plant and insect reproductive media, and pathogens can be destroyed or minimized. Chemical and pH adjustment with additives from industrial or agricultural waste can enhance the value of both liquids and solids. Materials that are not waste such as sugars, lime, acid, or oils can also be utilized to manipulate biological results. The end products of BPBU can be tailored to the needs of the recipient site. The volume available for mixing and buffering is a major advantage when comparing this invention with existing systems.

Facilities utilizing this invention feature liquids and solids that can be utilized for pH control used for acid materials treatment (such as mine waste) and metal stabilization. Beneficial materials are furnished that supply micronutrients, nitrogen, phosphorus, metals, beneficial bacteria. Bacteria furnish disease resistance/inoculant substances, insect control, antifungal characteristics, and general pathogen control.

3. Treatment of resistant contaminants such as chlorinated solvents and pesticides through sequential exposure to aerobic and anaerobic environments is a feature of this processing system. Increased remediation capability through the combination of aerobic and anaerobic exposures significantly increases the effectiveness of the treatment. The system mixes and selects bacteria to achieve an optimum group of organisms. The optimum mix of the various types of bacteria available to the facility can be manipulated and manufactured for the purpose of material stabilization or remediation. Mixing bacteria from multiple sites, or multiple extraction points within individual waste piles or landfills can be utilized. Mixing and dilution of contaminated materials reduces toxicity such that toxins can be biologically reduced to nontoxic components. Isolating optimized bacteria and contaminants results in a decontaminated material because the bacteria are forced to consume even the most resistant and toxic contaminants. The timely removal and use of the acclimated bacteria is a feature of this invention. Reintroduction of the bacteria with the optimized ability to degrade toxins and waste leads to further enhancement of the process capabilities. Combining multiple sites leads to additional capabilities.

The combination of anaerobic and aerobic treatment has benefits to the anaerobic solids portion of the system. The sequential cleaning of liquid distribution components of the anaerobic system with aerated liquid will maximize the efficiency of the distribution system. Digestion of anaerobic sludge and precipitates improves the liquid distribution of the anaerobic organic materials and liquid storage vessels. Anaerobic liquid extraction apparatus can be cleaned and revitalized. Utilization of the treated aerated liquid reduces or eliminates emissions from the uncapped areas and liquid collection systems of the non-aerobic site. The utilization of the aerobic treatment on anaerobic organic materials that is no longer an effective gas producer minimizes environmental liability and prepares the facility for alternative uses. Use of the BPBU process enhances the capabilities and value of anaerobic systems.

Wastepiles and liquid storage vessels will be utilized to reduce toxicity and facilitate the treatment of contaminated materials. Multiple wastepiles unlimited distances apart or waste masses that contain both anaerobic and aerobic zones are utilized to optimize treatment of both liquids and solids. Materials are treated in combinations of solid, liquid, anaerobic, and aerobic environments. The transfer between the various media is simple and effective and can be combined with other auxiliary treatment components to manipulate results. The use of filtration such as reverse osmosis nanofiltration can be used to concentrate bacteria for transfer to a treatment site for remediation or beneficial application to plants. Removal of specialized treatment organisms that will be used on persistent contaminants can drastically increase the speed of the next treatment. The use of the auxiliary treatment components can speed the discharge of liquids to surface or groundwater. Liquid containment is a very effective tool to change between the environments because it is simple to manipulate oxygen content.

Chlorinated contamination can be treated anaerobically first, then aerobically, then back to anaerobically. The sequence can start and end in either environment and in either media. The invention offers large advantages over existing methods because of enhanced control and flexibility. The system is adjusted to suit the large number of variables that are inherent to contamination treatment. Waste strength, ambient temperature, and available equipment are significant variables and controls that the invention includes. Placing a BPBU site in a brownfield site to treat both surface and water contamination is an excellent utilization of the invention.

Starvation treatment is an important aspect of the invention. Developing a thriving biological treatment is critical capability of the invention; starvation treatment is the ultimate utilization of the bacteria. The most persistent contaminants will require the media to be isolated while containing the contamination and an organism that is capable of complete or partial degradation of the targeted contaminant. The most toxic of materials are consumed when no other energy source is available. The treatment organism reduces the contamination because there is no alternative energy supply. Biological selection controlled by the invention furnishes the organisms. Control, in the form mixing, transfers, and breeding in the liquid and solid environments in conjunction with multi-site transportation furnishes optimum treatment. With particularly difficult contamination, multiple starvation treatments may be required to address toxic daughter compounds. A reduced contaminant may still be unacceptable for release into the environment. Material containment or isolation vessels can be sealed completely from the outside environment with liners and covers to improve performance. The invention furnishes the control required for a quantum leap forward in treatment. Use of small doses chemical compounds, nutrients, and or organisms to address plumes in groundwater is overshadowed by the massive remediation power and volume that is being made available.

Seeding of a liquid or solid treatment area with the appropriate daughter contaminants can furnish optimum bacteria at the optimum moment. Liquids or solids that have been processed by bacteria that have been driven to brink of starvation are exceptionally effective at degrading the next dose of contaminant in the same isolation. Manipulation of the treatment characteristics of the BPBU facility to match the characteristics of remote contaminated sites that requires treatment is a unique aspect of this inventive system. The manipulation of oxygen within the liquid or solid bacteria breeding ground is a simple illustration of the many factors that can be controlled and utilized by this invention.

For energy recovery an anaerobic treatment containment is formed with impermeable membranes and a gas extraction which the materials to be digested are added. The vessel contains liquid extraction media that are isolated from oxygen unless sequential treatment is required. The media is utilized to induce flow, extract liquid, and influence the migration of gas. Injected liquids, nutrients, gas, solids, and/or organisms influence the migration and/or production of gas. The slopes of the material are low and the containment berms are built to deal with plastic movement of the degrading material. New material is added to one end of the containment as gas is extracted from beneath the membrane at the other end of the anaerobic area. After gas production is no longer desired, the material is digested aerobically, utilizing the existing media and BPBU technology. During initial filling or after gas extraction is complete; the BPBU emission cover seals in, collects, or oxidizes emissions. During gas harvesting the cover collects gas and the extraction channels are used as gas collection vessels. Vacuum points within the solids control or influence flow of liquids, organisms, and gas. Aerobic treatment in the channels will eliminate emissions after gas production is terminated. Channels can be used for distribution of aerobic liquid into the solids. Vacuum points within the solids control or influence flow of liquids, organisms, and gas. Channels and liquid distribution system is used to incorporate organisms. After digested waste removal is complete, the cycle can be restarted.

Facilities utilizing this invention feature sequential treatment consisting of combinations of;
anaerobic to aerobic or aerobic to anaerobic exposures in multiples
injection anaerobic or aerobic liquid, gas, or solid into targeted materials

Isolation and movement—treatment and optimizing organisms by contamination addition;
so in the isolation treatment portion of the invention, just before the organisms starve to death, the organisms commonly achieve a numerical peak and are highly effective
with addition from destinations added to acclimate the organism
with isolation for forced to consumption and organism selection of even the highly persistent or toxic materials such as drugs, pesticides, or hormones
from other sites, extracted organisms, daughter products and the associated reducing organisms, or similar contaminants are utilized for seeding
at that time of maximum population, the organisms can be transferred off site or to another area within the current site
for transfer to a remote site with biologically adapted organisms drastically reduces treatment time and increases the intensity of treatment
as pH and other modifiers are utilized to facilitate acclamation and optimize treatment
with extremes of environment and toxins to kill all but optimum characteristics
allow optimized organisms are forced to proliferate in preparation of utilization

Mixing—solids and or liquids for acclimation and optimum organisms furnishes;
organisms that are the strongest and most suitable for digestion of materials
mixtures to acclimate organisms both to optimum treatment environments and to the remote environments that the organisms will be utilized in
exposure to conditions of destination and a massive number of the organisms
   Mixing—toxicity reduction furnishes;
lower concentrations of contamination facilitates the reduction/digestion of the toxin
in the diluted, contaminated environment, organisms are furnished with an opportunity to adapt that is not available at high concentrations of the toxic material
a graduated increase in contamination, furnished by the invention, produces an organism that is adapted to treatment conditions of a remote location
the massive influx of acclimated organisms causes successfully remediation
the retention time and the intensity of treatment offer the opportunity to treat persistent chemicals and synthetic compound such as drugs and hormones
with gradual addition of contamination, a refined and specialized treatment population is maintained at optimum levels
a continuous flow scenario of addition and removal that will maximize the quantity of contamination treated

4. The liquid drainage features of the Transformer treatment system are exploited to extract, transfer, and maintain live bacteria. The use of pumps, vacuum, excavation, and enhanced gravity extraction are attributes of this invention. Pulling liquid, gas, organisms, and/or oxygen through the aerobic solid portion of the system significantly increases bacteria populations and bacterial vitality. The siphoning of oxygen into the organic materials improves the biological conditions within the organic materials. Rapid throughput of oxygenated liquids increases the area of treatment and reduces the likelihood of greenhouse gas production. The accelerated transfer of aerated liquids or spent liquid through the organic materials improves the speed and effectiveness of aerobic digestion utilizing dissolved oxygen.

Pulling liquid, gas, and/or organisms, through anaerobic solids will increase the throughput and therefore the treatment capacity of the system. The rapid movement of liquid, gas, and/or organisms through the organic materials and the associated distribution of anaerobic bacteria increases biological activity. Current digestion systems require pulping or mixing to treat mixtures up to 15% solids. The invention minimizes processing and treats solids at above 15%, maximizes capacity, and minimizes costs.

Increased anaerobic biological activity increases maximum gas production and overall gas production while reducing the length of time that gas production occurs. Increased exposure of toxins such as chlorinated solvents facilitates the accelerated and improved degradation of material. Mixing in the liquid containment and the organic materials turns the two components into an efficient anaerobic processing unit with very large and cost effective treatment capabilities. The use of vacuum liquid extraction and pumping in addition to supplemental drainage increases the liquid throughput and liquid storage recharge. The treatment capability of the facility, both processing the organic materials and processing the contaminants in the liquid is dependent on liquid throughput.

Live bacteria rapid extraction from the solid organic materials and the liquid storage/treatment vessels of the invention furnish the opportunity to produce generations of increasingly acclimated organisms to be utilized for in situ treatment at other sites or other areas of the current site. Bacteria evolve on an exponential scale. Treatment speed, diversity with specialized contaminants, and accelerated ability to adapt are all features of the invention. When in transition between contamination sources, the minimization of variables increases the speed of acclamation in individual treatment areas.

The Transformer process includes the augmented removal of liquids from the organic materials to decrease hydraulic cycle times, biological cycle times, increase biological populations, and improve control of the process. BPBU takes the process further by redesigning liquid collection system in organic materials for the transfer of live organisms. A coarse filter/strainer system at various levels in the waste mass facilitates the removal of an optimum volume of live organisms. Sand, permeable membranes, or geotextiles that impede the movement of organisms will be avoided. Design with emphasis on open channel flow is used. Pumping of liquid and live organisms from the interior of the organic materials (wherever the biological populations are optimum), is an aspect of the invention that increases the transfer of biological populations and treatment capability. These aspects of the invention also improve the movement of liquids and oxygen through the waste. The combination of pressure, vacuum, and open channel flow maximize treatment.

The use of suction of any manner to remove liquids from the waste mass is a version of the invention. Suction can be produced by pumping of liquid, siphoning, introduction of vacuum, or any other process that increases flow. The suction of contaminated liquids through anaerobic organic materials increases the treatment efficiency of the anaerobic zone. Difficult to treat materials such as chlorinated materials are exposed and treated more effectively by this process. The use of gravity to induce suction on an internal drainage line is an opportunity to extract internal bacteria without an external energy source. Sequential aerobic/anaerobic treatment can be utilized to manipulate pH and optimize gas production.

Facilities utilizing this invention feature:
Anaerobic treatment of high solids materials
Rapid movement of bacteria and increases in treatment capability
Reduced greenhouse gas production in aerobic organic materials
Reduced greenhouse gas releases and energy recovery by anaerobic containment
Increased opportunity for from the aerobic organic materials
Increased quality and volume of gas recovery from the anaerobic organic materials
Rapid treatment and movement of contamination
Rapid increase of hydraulic “cycle” speed and movement of oxygen and/or organisms
Rapid increase in biological exposure and biological vitality
Expanded range of organisms that can survive in the solid and liquid treatment areas
Facilitation of the transfer of organisms into other treatment sites
Isolation of anaerobic and aerobic zones of the organic materials to facilitates combined treatment

5. A feature of the invention is the ability to produce of large quantities of treatment bacteria that can be injected in situ or ex situ to degrade the contamination of soils and groundwater. The extraction of live bacteria from the organic materials facilitates the acclamation of the bacteria to the waste materials present. The addition of large amounts bacteria into contaminated materials outside of the systems containment facilitates in situ treatment. The original contamination that the bacterium was developed with can be at below detectable levels, below cleanup criteria, or above cleanup criteria when it is added. The characteristic of the injected mixture will be adjusted to optimize the effects of the in situ treatment.

The mixing of multiple sites and multiple areas within sites will facilitate the refinement and effectiveness of the degrading organisms. Exponential reproduction is manipulated by furnishing all components needed for the bacteria to thrive. The massive biological population can be used as a tool to process, isolated, or control contaminants in both in situ and ex situ applications.

Ex-situ anaerobic treatment in zones or organic materials of a BPBU facility furnishes an amazing flexibility of treatment. The BPBU facility develops synergistic efficiency when the optimized treatments are combined. Because of the invention's ability to produce larger quantities of beneficial bacteria then any other process, the ability to treat both in situ and ex situ is significantly improved. The production capability permits in situ treatment of contamination sources and contamination plumes plus control of migration of the plume.

Permeable barriers of digested solids, produced from organic materials, make a superior control or treatment device on anaerobic materials.

The transfer of BPBU liquids to an area of contamination is an important part of this invention. The transferred liquid can contain contamination above, below, or at the cleanup target for the destination site. Site specific regulation, costs, and the needs of the biologic treatment organisms will dictate the characteristics of the transferred liquids.

Facilities utilizing this invention feature production of large quantities of organisms:
available for in situ or ex situ treatment
available to contain a contamination plume
available to treat a contamination plume
available to treat a contamination source
adjusted to destination characteristics
in liquids or solids from the original BPBU waste, the destination site, or from contaminant seeding containing contamination below detection, below cleanup criteria, or above cleanup criteria
large quantities of organisms grown in both or either solid and liquid containment

6. When a material has been partially digested, the addition of worms, insects, and plants, in addition to bacteria and fungi nurtured by the Transformer process, can be utilized to increase the value of the treated materials, reduce costs, and improve treatment efficiency.

The aerobic digestion of organic material significantly influences the toxicity of materials. Pretreatment of organic materials with aerobic or a combination of aerobic and anaerobic bacteria, expands the opportunity for treatment by higher-level organisms. The effectiveness and speed at which biological treatment by higher organism can take place is enhanced by BPBU. The use of the higher-level digesters after BPBU or Transformer treatment is part of this invention.

Facilities utilizing this invention feature:
Worms, insects and greater range of bacteria working in the treated waste
Increase quality of product after digestion
Matching of treatment to the level of digestion and waste toxicity on an individual basis

7. Energy produced from the gas of the anaerobic waste mass and liquid storage vessel is a valuable resource. Gas production The treatment system can be arranged to extract gas from the anaerobic organic materials that is utilized to heat and power the rest of the system. High energy waste that degrades quickly can be processed anaerobically for gas extraction, aerobically degraded for volume reduction and sterilization, and then be used as fertilizer or as an emission oxidizing cover. Additional methogenic organisms produce additional gas when circulated in the organic materials or in the liquid containment. The rapid transfer of liquid facilitates the extraction of heat from the liquid for beneficial purposes. Additional aerobic organisms produce additional heat and additional digestion when circulated in the organic materials or in the liquid containment.

### Summation of Prior Art:

The Transformer Process was a milestone in treatment technology. It utilizes water and dissolved oxygen to facilitate the controlled decomposition of organic materials in a waste mass. This invention is the optimization and control of the processing of organic materials (liquids, gas, solids, nutrient, organisms and combinations thereof) with aerobic, anaerobic, and combined treatment with powered flow aimed at optimizing degrading organisms, exposure of components, or conditions. PreTransformer system do not manipulate organisms, strategically induce flow and transfer of liquids, nutrients, gas, solids, and/or organisms, produce optimized populations or conditions, exchange organisms, sequentially treat, treat high solids materials, cycle materials, utilize starvation treatment, train organisms, breed generation of incrementally improved organisms, or protect organisms. Prior art concentrates on small batch systems, simple addition of liquids, flows constrained by anaerobic bacteria, and random gravity drainage.

What is claimed is:

1. The Transformer Process utilized the addition of oxygenated liquids to materials, gravity drainage, additional drainage for liquid control, additional membranes for liquid control, and the development of aerobic organism in liquids and solids. The improvement comprises an accelerated ex-situ or in-situ, aerobic or anaerobic, single site or multiple site, new facilities or retrofit facilities, sources or plumes, hydraulically contained or not, digestion/treatment method for processing organic materials through oxidation and reduction contained in liquid, gas, or solids through augment and improved biological activity comprising of;
one or more liquid tight containment structures for holding a volume of biodegradable organic solids, liquids, and other materials;
one or more soil and water sites that are to be treated or used for treatment in-situ
one or more liquid introduction systems that can move liquids between combined, liquid, and solids containment structures or sites and introduce liquids, with and without aeration, to a multitude of points within the containment structures or sites
one or more additional liquid sources of varying levels of purity and utilization of existing liquid
the augmented or enhance treatment achievable by forced flow of liquid, gas, and organisms with materials
the delivery of previously unachievable large quantities of optimized organisms

2. The method as in claim 1, wherein said solid or liquid and biological mixture is transferred between any combination of anaerobic or aerobic controlled containments, to improve the characteristic of the contained evolving organism population and processing of the degradable materials comprising of toxins, drugs, hormones, pathogens, spores, seeds, chlorinated compounds, or other persistent materials.

3. The method as in claim 1, wherein an augmented, adapted, and continually evolving microorganism population is adjusted and controlled in the changing conditions within the containment structures or sites through the manipulation of biological exposure, organics content, oxygen content, temperature, toxin content, nutrient addition, or any other controllable parameter.

4. The method as in claim 1, wherein said liquid or solid is processed with any combination of sequential anaerobic or aerobic conditions, within containments or sites, enhanced with additives, augmented with offsite organisms, and augmented with nutrients such that the biological organisms and nutrients found within are capable of increasing vitality, disease resistance, insect resistance, or growth in plants in quantity greater than 500 gallons.

5. The method as in claim 1, wherein aerobic or anaerobic mixtures of liquids or solids and the associated augmented biological organisms are cycled through one of more containment structures or sites such that even highly toxic or persistent contaminants are degraded and diluted such that;
the mixture to be released or transferred to another location per regulatory policy as clean of degrading biological organisms and/or contaminants
large numbers of contaminant degrading biological organisms are present
a regulatory defined, small amount of contamination and large numbers of contaminant degrading biological organisms are present in the discharge or transfer
the mixture to be released per regulatory policy is used as treatment option for injection into the current site
the mixture to be released per regulatory policy is used as treatment option for injection into another site
continuous input of contaminated materials into the treatment system results in continuous output of treated material from another portion of the system
multiple combination of the above conditions exist simultaneously within the system

6. The method as in claim 1, wherein the solid surface of the containment is aerobically treated with aerated liquid to become a biofilter or the containment is covered with aerobically treated materials to become a biofilter to consume emissions that are produced beneath and eliminate or minimize the need for a gas collection system.

7. Sites are currently seeded with organism to treat contaminants while the improvement of this invention is the ability to furnish massive quantities of organisms or massive quantities of adapted organism for addition to the current site or other sites.

8. The method as in claim 7, wherein destination containments or sites of the transferred material that are controlled and optimize biological growth conditions for the delivered bacteria and said organism contribute to the vitality and degradation effectiveness of the resultant mixtures in both the in-situ and ex-situ applications

9. The method as in claim 7, wherein excavation of solids occurs to remove organisms for use elsewhere or to increases internal flow of liquid and organisms within the material

10. The method as in claim 7, wherein use of controlling features such as manipulation, addition to, concentration of, and/or removal of isolated organisms to of acclimate them to another location's conditions and therefore develop modified processing capabilities for use at another sites with differing oxygen or contamination conditions such that the input mixture eliminates or reduces the source of contamination or a resultant plume within the in-situ contaminated material while none or some portion of the input mixture is recovered for processing, reinjection, or augmentation.

11. The method as in claim 7, wherein said biological organisms mixtures found in multiple sites are actively exchanged, mixed, trained with contaminants, trained with nutrients, trained with conditions, or otherwise acclimated to destination conditions, within the liquids and solids of the initial containment structures and sites.

12. Covered and contained vessels have been utilized for many decades to treat materials, the Transformer process utilizes the injection of aerated water, while the improvement furnished by this invention is comprised of; increased flow of liquids, nutrients, gas, solids, and/or organisms and exposure of the targeted materials control the speed and effectiveness of degradation; manipulation and material handling that creates and optimizes flow, delivery, and exposure; induced internal flow and/or exposure due to pressure, vacuum, and other utilization of energy; flexible cover or covers that expand and contract to store energy for use as is needed and maintains positive or negative pressure of either an aerobic or aerobic nature that isolates and increase internal flow; flexible portions of a cover or covers that expand and contract as is needed and maintains positive or negative pressure that isolate the system and increase internal flow; channels placed in the solids, at an interval dependant on the targeted materials, that increase the release gas, liquids, and/or organisms and increase internal flow; channels for the routing of liquids, nutrients, gas, solids, and/or organisms beneath the cover; permeable materials arranged on the containment, site perimeter, solids or liquids for the routing of gas and liquid beneath the cover; addition locations for liquids, organisms, solids, and/or gas in the solids such that internal flow, chemical exposure, and biological exposure is improved; vacuum, siphon, or manipulation of gravity applied at various points within the solids or beneath the cover such that the applied vacuum, siphon, or manipulation of gravity increases internal flow and exposure of the targeted materials; drainage cut in the solids such that flow of gas, liquid, and organisms work in conjunction with the injection and the vacuum.

13. The method as in claim 12, wherein mixtures of liquids, nutrients, gas, solids, and/or organisms are added to one or more locations in the solid or liquid and removed from one or more other locations, such that a system with optimized flow and treatment comprises of one of more of the following arrangements;
one or more liquids, nutrients, gas, solids, and/or organisms extraction system that increase internal flow of liquids, nutrients, gas, solids, and/or organisms through vacuum, pumping, siphon, or any other process in excess of gravity drainage in containment structures or sites
one or more liquids, nutrients, gas, solids, and/or organisms injection systems that increase internal flow of liquids, nutrients, gas, solids, and/or organisms through vacuum, pumping, siphon, or any other process in excess of gravity drainage in containment structures or sites
extraction points for liquids, nutrients, gas, solids, and/or organisms dislodged from the targeted material
sealed extraction points of the solids, covers, or outer surface features such as pipes or voids that facilitate enhanced or controlled internal flow of liquid and organisms
accelerated removal and/or harvesting of live organisms, preservation of population, and increasing population during removal and deposition of said organisms resulting from the liquid extraction, sustaining material addition, pressure and/or accelerated internal flows
liquids, nutrients, gas, solids, and/or organisms removal that creates an accelerated migration of liquids, nutrients, gas, solids, and/or organisms that was resident to other portions of the containment structure towards the extraction point
sealed extraction points or outer surface features such as pipes or voids that are utilized to induce, isolate, modify, treat, or otherwise manipulate both internal flow of liquid and movement of live organisms from the interior of the in-situ and ex-situ applications
solids that are partially to completely saturated with liquids in order to induce and control internal flow of any combination of liquid, oxygenated liquid, anaerobic liquid, gas, or organisms when said liquids, nutrients, gas, solids, and/or organisms are added and removed
the direct aeration of saturated or flooded solids or the removal of liquids, nutrients, gas, solids, and/or organisms in combination with the addition of aerated liquid such that the saturated solid-liquid mixture has an increased oxygen content and increased aerobic digestion

14. The method as in claim 12, wherein said biological organisms mixtures and contamination are manipulated, cycled, diluted, concentrated, and treated with any combination of additives, contaminants, cultured organisms, nutrients, or any type of concentration device while within or during transfer between the containment structures, sites, discharge structures, or off site transport such that the contaminate is reduce and the biological ability of the mixture to reduce is enhanced.

15. The method as in claim 12, wherein said biological organisms mixtures are extracted and transported between one or more sites are biologically protected with regards to atmosphere, adequate energy sources, temperature, or any other condition variable within the liquids and solids to optimize treatment capabilities of the delivered organisms.

16. The method as in claim 12, where in the method is comprised of one of more of the following practices or features being utilized to improve flow and conditions for proliferation of biological activity;
inflated bladders or materials with insulating characteristic are added to one or more points on the liquid or solid surface
liquids, nutrients, gas, solids, and/or organisms under the cover are heated or cooled directly
containments are built below grade or of sufficient thickness to capture the insulating character of the soils
gas is heated or cooled externally and added while cooler atmosphere or liquid is extracted elsewhere in the system, reused or removed from the system
liquid is heated or cooled externally and added while cooler or warmer atmosphere or liquid is extracted elsewhere in the system, reused or removed from the system
heating, cooling, and transfer is done to maintain, enhance, otherwise manipulate the desired biological activity and conditions

17. The method as in claim 12, wherein liquids, nutrients, gas, solids, and/or organisms are discarded, processed elsewhere for disposal, utilized in other areas of the current containment, utilized at other ex-situ sites, utilized for in-situ treatment of the current site, utilized for in-situ treatment of other sites, or utilized to develop improved plant characteristics.

18. The method as in claim 12, wherein there is utilization of a system or one or more independent or dependent covers to accomplish any or all of the following functions;
shed or capture precipitation
isolate the atmosphere around materials to be processed
collect, isolate, or disburse gas
retain or dissipate heat
collect, isolate, or disburse solar energy
increase evaporation
decrease evaporation

19. The method as in claim 12, wherein liquids, nutrients, gas, solids, and/or organisms are collected, made anaerobic or aerobic in the collection points or elsewhere, combined with liquids, nutrients, gas, solids, and/or organisms, placed into or out of the system to achieve benefit.

20. The method as in claim 12, wherein enriched liquids and liquids, nutrients, gas, solids, and/or organisms flood or saturate existing solids, liquids, nutrients, gas, solids, and/or organisms and are drawn out and placed elsewhere in the containment or outside the containment such that liquids, nutrients, gas, solids, and/or organisms are cycled through the system, utilized elsewhere, or discharged from the system benefit in a continuous manner to maintain constant optimized processing or batch treatment.
